(19) United States
(12) Patent Application Publication
(10) Pub. No.: US 2008/0140681 A1
(43) Pub. Date: Jun. 12, 2008

(54) Functionality for Online Dating Application

(76) Inventor: Adewole Ajibade, Houston, TX (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/609,371

(22) Filed: Dec. 12, 2006

(51) Int. Cl. G06F 17/30

(52) U.S. Cl. 707/100; 707/E17.005

(57) ABSTRACT

A systematic method is disclosed for securely setting up a date in online dating applications. The first step allows a requesting member to request a date with a requested member. Next, the requesting member can enter a meeting date, place, and time. The requested member will then be prompted to either accept or decline the date request from the requesting member. The method also provides a dating history database which records a members' dating history. In addition, a method of ensuring a member's safety by allowing members to choose to have someone contacted if the member does not update the dating history database after a date is disclosed.

### FIELD OF THE INVENTION

The present invention is directed toward online information systems. More specifically, the invention is directed toward functionality that can be incorporated into online dating applications to give users a sense of safety when they go out on a date with other members.

### BACKGROUND OF THE INVENTION

Many online dating services have emerged as the wealth of resources and ease of communication that the World Wide Web provides has been utilized to meet the needs of adults seeking to meet friends and life partners. These sites provide members with the opportunity to search for individuals with similar interests or goals from the convenience of their home PCs. These sites provide methods to allow users to correspond online. Many members, who have met online and interacted virtually, eventually have the desire to meet in person. This can expose members to potential danger, since the security at this point of communicating from the privacy of one's home is eliminated. Indeed, most users have a sense of apprehension before going to meet someone in person whom they have never seen before. This uneasiness is heightened because dating sites do not conduct a criminal background check on members. In fact, the internet has become a breeding ground for deception and a tool for cyber criminals. This danger has created a need for the current invention to provide a sense of safety and peace of mind to users of online dating applications.

There have been a number of systems directed to online dating services and more specifically toward methods which allow users to set up meetings with other members. However, these systems lack the ability to give users a sense of safety before a meeting is arranged and the functionality to alert the user's loved ones in the case the user does not return from an arranged meeting.

U.S. Pat. Nos. 6,594,502, 6,665,389 and 5,963,951 all disclose online dating systems. However, these systems do not provide a method to track the dates that users have set up and gone on.

There have been many inventions directed towards methods of setting up virtual meetings. These include U.S. Pat. Nos. 6,363,352, 5,261,045, 5,317,683, 5,197,000, 5,303,145, 5,124,912 and 5,208,748. Unlike the current invention, these disclosures do not provide the ability to track whether users have returned safely from their meetings.

Consequently, there is a need for a system for online dating services to gives users a sense of safety when they arrange physical meetings with other users and to track whether users have returned safely from dates that were scheduled online. Accordingly, the present invention described herein encompasses these features.

### SUMMARY OF THE INVENTION

It is an object of the present invention is to provide a method to set up dates for online dating applications. The ‘set up date’ functionality allows the user to set a meeting time, date and location.

It is a further object of the present invention to provide a process to keep records of dating activities. A dating history database has the functionality to keep records of requested dates, accepted dates, dates declined, time and location of dates attended, user name of requester, real name of requester, and the like.

It is a further object of the present invention to provide a sense of safety for members of online dating communities who wish to meet other users in person. The functionality of the current invention will allow users to update the dating history database to indicate whether they have returned home safely from their date. In the case that the database is not updated, an emergency contact of the user will be alerted that the user has not returned, along with the meeting date, time, and location and the real name of the individual the user went to meet.

Other objects, features and advantages of the present invention will be apparent from the accompanying drawing and from the detailed description which follows.

### BRIEF DESCRIPTION OF THE FIGURES

FIG. 1 is a sequential diagram showing the first step in the process of setting up a date for an online dating application.

FIG. 2 is a sequential diagram showing the second step in the process of setting up a date for an online dating application.

FIG. 3 is a sequential diagram showing the third step in the process of setting up a date for an online dating application.

FIG. 4 is a sequential diagram showing the fourth step in the process of setting up a date for an online dating application.

FIG. 5 is a sequential diagram showing the fifth step in the process of setting up a date for an online dating application.

### DESCRIPTION OF THE INVENTION

It will be readily understood that the steps involved in the method of the present invention, as generally described herein, could be arranged and designed in a wide variety of different formulations. Thus, the following more detailed description of the embodiments of the compositions or formulations of the present invention are not intended to limit the scope of the invention as claimed, but are merely representative of the presently preferred embodiments of the invention.

Reference will now be made in detail to the presently preferred embodiment of the invention, which is illustrated in the accompanying Figures, wherein like reference numerals refer to like elements throughout.

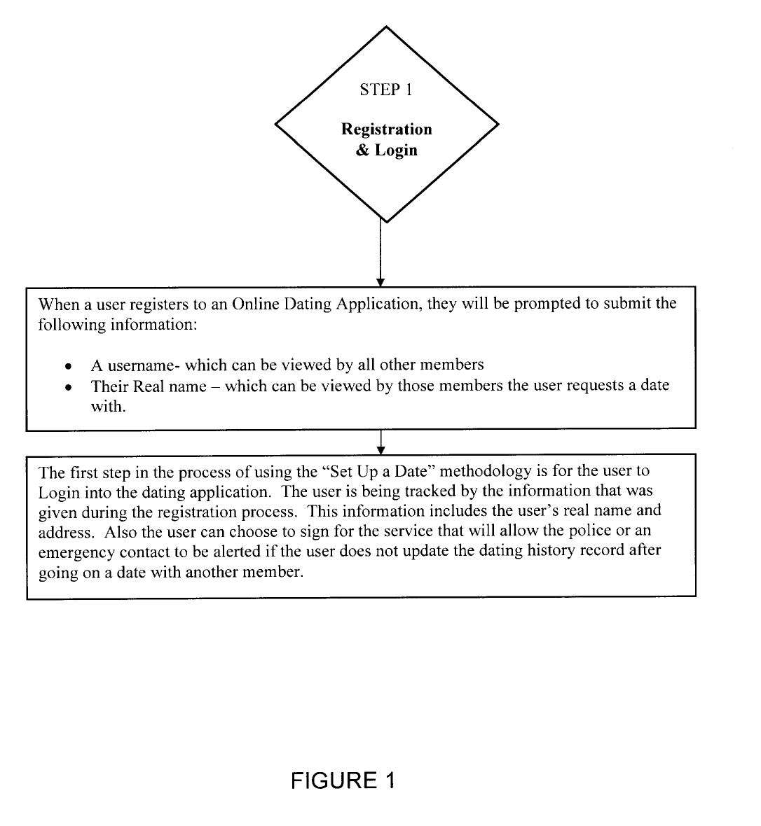

FIGS. 1 through 5 show a block diagram process flow of the preferred embodiment of the present invention. The process flow provides the steps required to set up a date for online dating applications as currently disclosed.

Referring now to FIG. 1, the first step of the method of setting up a date for an online dating application is shown. When users register to become members of online dating communities, they are prompted to enter a great deal of personal information. The relevant information that will be needed for the ‘set up a date’ methodology is their real name and user name. A user's real name is their first and last name. When a member requests a date, the requested member will see the user's real name. This will reduce the likelihood that a member would contact another member for a date with fraudulent or inappropriate intentions. The reason for this is that they are being tracked by their real name and would be reluctant to commit any wrongdoing under the risk of being caught easily. The first step in the ‘set up a date’ process also involves the user to enter a username. This will be the name that members will see when searching for other members. At this point, a user can also enter emergency contact information that will be later explained in step five of the ‘set up a date’ process.

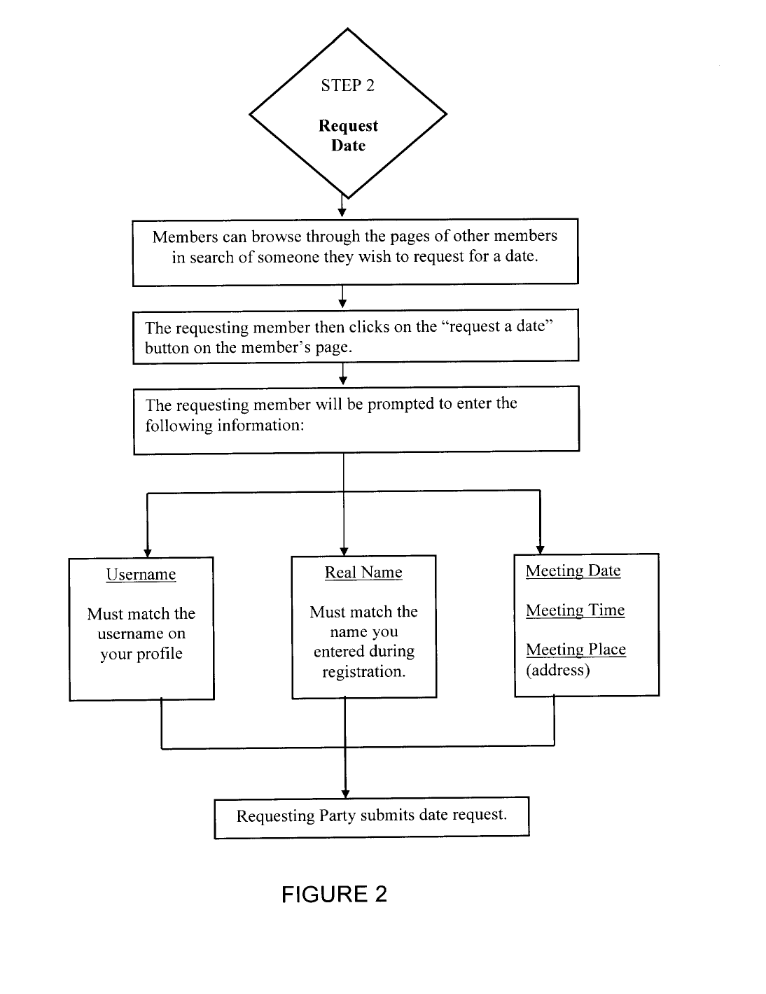

Referring now to FIG. 2, the second step of the method of setting up a date for an online dating application is shown. Once a member has registered, they can browse the online dating application to view other members. These members will be labeled under their usernames. When the user finds a member he/she is interested in, he/she may contact the member. Once the two members communicate, one member may choose to request a date. While the members may do so in a traditional manner via telephone call or email, the ‘set up a date’ process herein described offers a safe alternative that will allow members to request and accept dates while maintaining a sense of security regarding their personal safety.

Still referring to FIG. 2, when a member wishes to set up a date with another member, he/she will click on the “request a date” button on that member's page. The requesting member will then be prompted to enter the information including their username, their real name, a meeting time and a meeting place. The username and real name must match with the information entered during the registration. This will prevent a person from requesting a date under another member's username or real name. The meeting date must be a specific day in the future. For example, a date can be requested for “February 17^{th}”, but not for “Next Week” or “the Day after Tomorrow”. In addition, the time has to be specific and cannot be a general time period. For example, an acceptable time would be 8:30 PM and not simply “In the Evening”. Further, the meeting place must show a specific address. This will help reassure the requested member that others will know exactly where the date will take place. An example of an acceptable meeting place would be “The Regal Theatre at 112 N. Broad St., Philadelphia Pa. 19370.” An example of an unacceptable meeting place is, “Downtown” or “In the Park.” To facilitate this process, drop down menus may be provided to input the day and time of the date. Additionally, an alternative embodiment of the process may also require that the address be verified as a real address from a reliable database. Once the requesting user has input all of the above information, the user may next submit his/her date request.

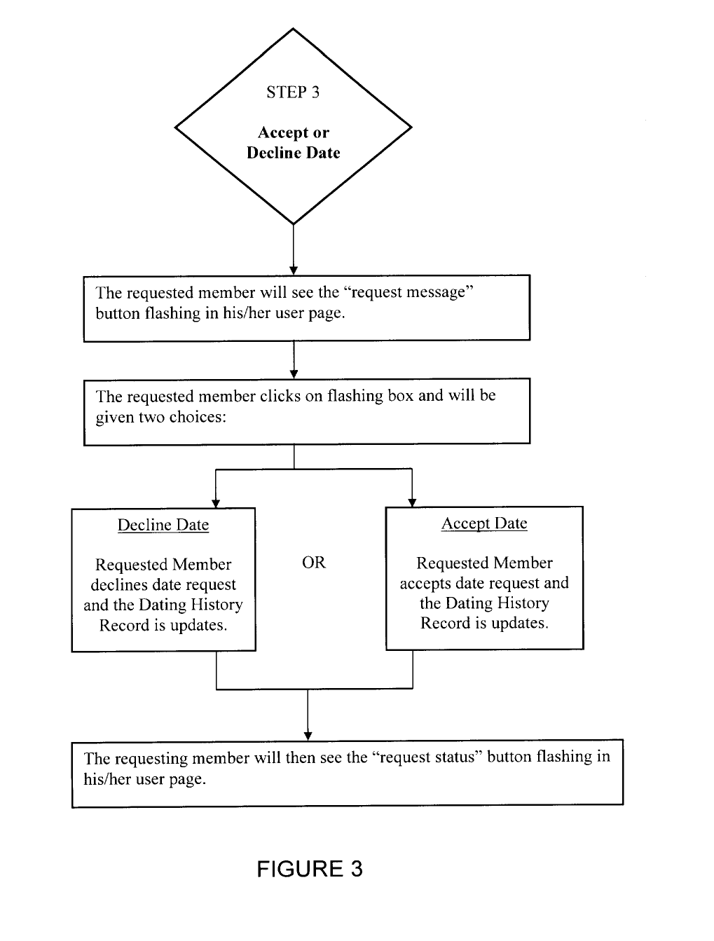

Referring now to FIG. 3, the third step of the method of setting up a date for an online dating application is shown. When a requested member receives a date request, they will see the “request message” button flashing on their page. This will alert the member that someone has sent a message. When the requested member clicks on the button, the member will be given the choice to either accept the date or decline the date. The requested member can accept or decline by hitting either the “Accept Date” button or “Decline Date” button. This will then send a response back to the requesting member. The requesting member will then see the “request status” button flashing on their page. This will alert the requesting member that they have received a response from their date request.

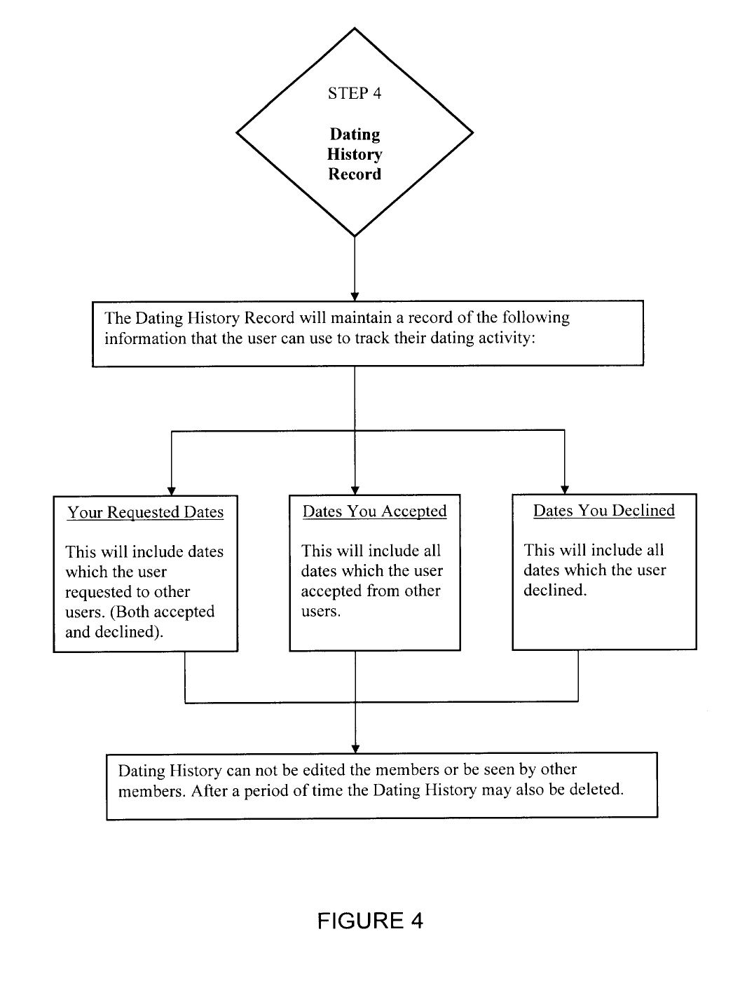

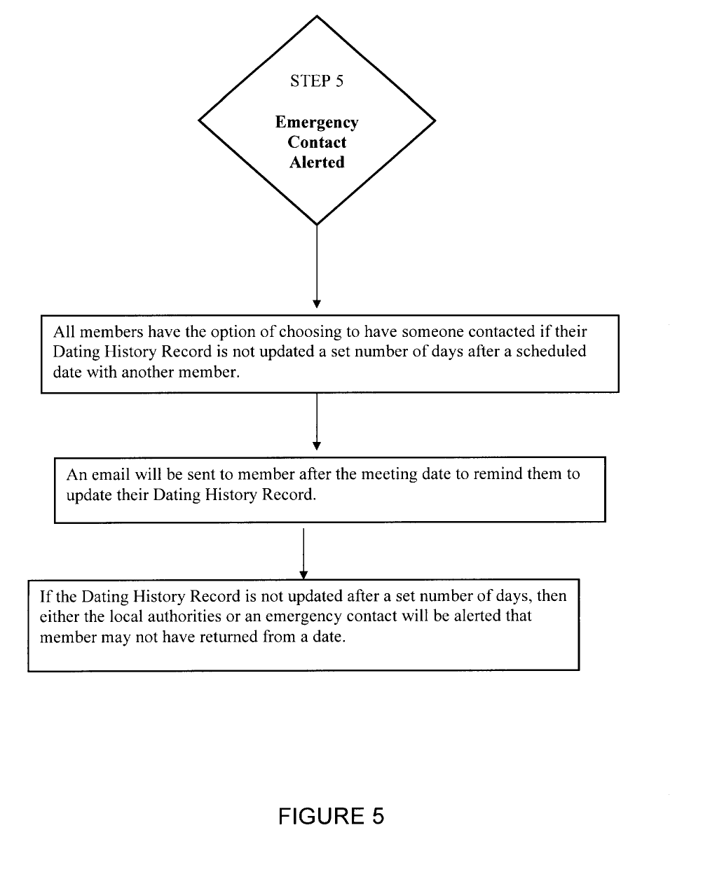

Referring now to FIG. 4, the fourth step of the method of setting up a date for an online dating application is shown. All members will have their dating history record updated when the member makes date requests, receives responses from their date requests, accepts dates or declines dates. The dating history record will also be updated when a member indicates that he/she has returned safely from the date if they choose to have the emergency contact measure, which is described in FIG. 5. When a member makes a date request, a record will be kept showing when the request was made, to whom it was made, when it was made, the details of the request, and whether the date was accepted or denied. When a member receives a date request, the dating history record will be updated to show who the request was from, the details of the request, and whether the request was accepted or declined. All of the above referenced information will be automatically input in to the dating history record when requests are made, accepted, or declined. As such, members will not be able to edit their own dating history record. Members will also not be able to view the dating history records of other members.

Referring now to FIG. 5, the fifth step of the method of setting up a date for an online dating application is shown. To provide another level of security and further ensure that members have peace of mind when using the set up a date methodology, members may choose to have an emergency contact designated. This emergency contact may or may not be the local authorities. Members may also choose to designate a close friend, relative, employer, or neighbor. Members who have chosen to designate an emergency contact will be required to update their dating history after the member has gone out on a date to show that the member has returned home from the date safely. This will then be reflected in their dating history record. After a set number of days after a date, if the member has not updated their dating history, his/her emergency contact will be notified. This notification may be made by an automated message or by a phone call from an administrator. If the member has safely returned, he/she can change the dating history after being contacted by their emergency contact. Under the unfortunate circumstance that the member has not returned, the emergency contact will be able to take the necessary steps in the best interest of the member. The process of having an emergency contact will give members a sense of safety as they use the set up date methodology.

It is appreciated that additional advantages, modifications and equivalent embodiments will be apparent to those skilled in the art. Therefore, the invention, in its broader aspects, is not limited to the specific details shown and described herein. Accordingly, various modifications may be made without departing from the spirit or scope of this invention as defined by the appended claims and their equivalents.

What I claim is:

1. A method of setting up a date for members of online dating communities, said method comprising of the following steps:
allowing a requesting member to request a date with a requested member;
allowing said requesting member to enter a meeting date, place, and time;
allowing said requested member to either accept or decline the date request from said requesting member;
creating a dating history database which records a member's dating history; and
a method of ensuring member safety comprising of allowing members to choose to have someone contacted if they do not update the dating history database after a scheduled date.

2. The method of setting up a date disclosed in claim 1, further comprising a security measure with the following steps:
members are tracked by their real names and user names which are input and assigned to the member's online profile during registration; and
a requesting member's date request will only be processed if the user name and real name entered with the date request match the real name and user name the member input during registration.

3. A method of setting up a date disclosed in claim 1, wherein the dating history database keeps a record of all the dates a member requested, all the dates a member accepted, and all the dates a member declined.

4. The method of setting up a date disclosed in claim 3, wherein the dates requested and the dates declined in the member's dating history database cannot be edited by that member or be viewed by any other member.

5. The method of setting up a date disclosed in claim 1, wherein the method of ensuring member safety comprises of the following steps:
members can choose to specify an emergency contact which may or may not be local authorities;
members can update their dating history database to show that the member has returned safely from a date; and
said emergency contact will be notified if the member has not updated his/her dating history database within a predetermined time period after a date was scheduled with another member.

6. The method of setting up a date disclosed in claim 1, wherein a link is used to indicate when a requested member has received a date request, said link flashing when an unread request has been sent to the user.

7. The method of setting up a date disclosed in claim 1, wherein a link is used to indicate when a requesting member has received a response to a date request, said link flashing when an unread response has been sent to the user.
